(19) United States
(12) Patent Application Publication
(10) Pub. No.: US 2012/0188939 A1
(43) Pub. Date: Jul. 26, 2012

(54) DYNAMIC WIRELESS NETWORKS AND INTERACTIVE WIRELESS INFORMATION COMMUNICATION AND DELIVERY SYSTEMS

(76) Inventors: David E. Brown, La Puente, CA (US); Rick Sturdivant, Placentia, CA (US); Aaron DeWitt, Corona, CA (US); Chris Turner, Orange, CA (US)

(21) Appl. No.: 13/010,437

(22) Filed: Jan. 20, 2011

(51) Int. Cl. H04W 88/06; H04W 64/00

(52) U.S. Cl. 370/328; 455/456.1

(57) ABSTRACT

Wireless information communication and delivery systems are described herein that include at least one wireless-enabled device, a device location system, a positioning and communication system, and an information repository system. A configurable wireless protocol device is disclosed that includes a multi-modal transceiver that can establish a communication network with a local wireless-enabled device. A wireless network is described that includes: at least one configurable wireless protocol device; at least one wireless-enabled device; and at least one wireless access point. Methods of locating a wireless-enabled device are described and include: providing a wireless-enabled device, providing a configurable wireless protocol device comprising a modified wireless-protocol; and utilizing the configurable wireless protocol device to actively scan for the wireless-enabled device.

### FIELD OF THE SUBJECT MATTER

The field of the subject matter is broadly a dynamic wireless network and more specifically, an interactive wireless information communication and delivery system is disclosed that includes software, hardware and related methods.

### BACKGROUND

Consumers who own and use wireless two-way communication devices, such as smart phones, personal digital assistants or PDAs, hand-held devices, and other two-way communication devices, are constantly looking for new ways to use that device to interact with one's surroundings and/or receive information about their surroundings or specific items in a certain range. In addition, consumers do not want to purchase, rent or carry additional devices other than their primary device mostly based on convenience. It is this desire that has caused the dramatic increase in device applications or software “apps” that allow the user to accomplish additional tasks on a smart phone.

For example, right now if a tourist wants to tour the Louvre in Paris, the tourist will pay a fee to enter the museum, buy a guide book and/or rent an electronic device that contains an education program on the artwork in the museum. The tourist then walks around the museum listening to the recording. The tourist must control the recording depending on where he/she is in the museum. The tourist must also follow a specified path, since the recording is fixed and cannot be changed based on location without re-recording the updated information.

There are some conventional systems that utilize the user's smart phone in some way. For example, there are some conventional systems that require the wireless-enabled device to scan for WIFI™ transceivers, which is a problem since some wireless-enabled devices from key suppliers such as Apple's iPhone™ will not permit their devices to be set into scan mode. In this instance, the wireless-enabled device is not able to detect the presence of transceivers. The iPhone™, and other similar smart phones, won't be able to “know” or “comprehend” the relative signal strength, and therefore the relative position, of nearby transmitters. Second, the existing WIFI™ devices are not able to limit their “receive” and “transmit” power and send the correct WIFI™ protocol.

Another issue with most conventional devices is that they require some added hardware by the smart phone user. Solutions such as Active Bat™, for example, require a special sound receiver and transmitter. Other WIFI™/GPS or global positioning systems solutions such as Sky Hook™ utilize standard WIFI™/GPS hardware but only provide a ten to twenty meter accuracy, which may not be very accurate for a moving or roving user in a large room with other users.

One additional piece of the puzzle is the information that is being accessed. As mentioned with the Louvre example outlined above, the user accesses a pre-taped recording that is laid out according to a specific path through the museum. Other conventional systems require users to press a button or activate a recording at the site of each individual piece of art or interesting item. Obviously, this solution is problematic, because tourists are constantly arriving at or leaving a piece of art, and so, if someone arriving at the piece of art presses the button to activate the site recording, another arriving late will not hear it from the beginning. Some conventional solutions link to web pages. None of the conventional solutions track interest expressed in a particular object and/or the time spent in front of that object by each individual observer. Conventional solutions also do not allow the tourist or observer to get targeted information and/or promotional items based on the time spent in front of the artwork. For example, it would be ideal if a system were produced that sent the observer a note about a sale on Monet posters in the gift shop, if the observer spent a lot of time looking at the Monet collection. Current solutions also lack the ability to manage information in diverse formats and to allow users to record interests in specific objects.

There are global positioning systems (GPS) and related software that allow a user or operator to get some information about a particular location. For example, when a driver is operating an automobile with GPS, the system will show the operator what restaurants or gas stations are at the upcoming exits. While the driver may arbitrarily decide to exit and pick the first restaurant, there is no information that can be transmitted to the restaurant as to whether the driver searched for that restaurant or restaurant chain, what that driver ordered when he/she stopped, whether the driver used the drive-thru window or came inside of the restaurant, and other information that may help the restaurant or restaurant chain better market to consumers. There are also no conventional solutions for pushing out promotions to the prospective consumers based on their previous preferences coupled with their immediate proximity to their desired restaurant or gas station chains.

In a smaller environment, a trade show usually has at least a hundred company booths with booth attendants who are trying to get someone to stop, chat, provide a business card and ideally, purchase what the company is selling. Trade show booths usually put out a fishbowl for business cards using a giveaway item as an enticement for the attendee to stop and talk or provide a business card. One of the new methods of getting information from attendees is for the booth workers to scan the badge of the attendee with a wireless scanner. This process results in a report being communicated to the company of additional information not usually found on a normal business card, such as what products the attendee is interested in, what journals the attendee reads, what type of business the attendee is in and other specific information provided by the attendee when registering for the tradeshow or provided to the organizing entity earlier. There is no method of tracking attendees from booth to booth, whether they approach a particular booth, determining how long they linger at a booth, whether they visit the booth multiple times and other information that may help the companies involved in the trade show.

Therefore, there is a need in the art for ideal systems that meet the needs and desires of both the consumer and the transmission-controlling entity, such as a museum, trade show, restaurant, sporting venue, retail outlet, theme park, hospital or any other suitable business. Specifically, there is a need for wireless information communication and delivery systems that provide at least one of the following: a) can provide communication between transceivers and wireless-enabled devices based on software applications; b) can provide communication between transceivers and wireless-enabled devices without the necessity of scanning by the wireless-enabled devices; c) can provide a wireless network that has transceivers having several modes of operation, including a limited interference mode that allows transceivers to only establish communication with localized wireless-enabled devices or a distant access mode that allows transceivers to communicate with distant wireless access points; d) enhanced user experience that is achieved by combining the configurable transceiver with a modified WIFI™ protocol; e) improved accuracy of the transmission of communication to the user as he/she moves around an environment; f) can utilize the information and experiences of other users to add information and improve accuracy of the information and experience; g) can utilize the information transmitted by other users to improve the information related to the distance above, below and around the observer; h) includes a system that can manage various formats of information, along with including the ability to search through the information system's history by using sophisticated and up-to-date search mechanisms and i) can provide promotional items or other information to a user based on the user's tracking input.

### SUMMARY

Wireless information communication and delivery systems are described herein that include at least one wireless-enabled device, a device location system, a positioning and communication system, and an information repository system.

A configurable wireless protocol device is disclosed that includes a multi-modal transceiver that can establish a communication network with a local wireless-enabled device.

A wireless network is described that includes: at least one configurable wireless protocol device; at least one wireless-enabled device; and at least one wireless access point.

Methods of locating a wireless-enabled device are described and include: providing a wireless-enabled device, providing a configurable wireless protocol device comprising a modified wireless-protocol; and utilizing the configurable wireless protocol device to actively scan for the wireless-enabled device.

### BRIEF DESCRIPTION OF THE FIGURES AND TABLE

FIG. 1 shows a contemplated wireless information communication and delivery system.

FIG. 2 shows a contemplated advanced network development diagram

A contemplated hardware transceiver is shown in FIG. 3.

Contemplated wireless information communication and delivery systems require that software-based digital data tags be associated with the tagged objects and appropriate applications software be downloaded and activated on the wireless-enabled devices, as shown in FIG. 4.

Table I outlines some of the messages that can be processed by contemplated wireless-enabled devices—in this case, smart phones.

### DETAILED DESCRIPTION

An interactive and dynamic wireless information communication and delivery system has been developed and is described herein that provides at least one of the following: a) provides communication between transceivers and wireless-enabled devices based on software applications; b) provides communication between transceivers and wireless-enabled devices without the necessity of scanning by the wireless-enabled devices; c) provides a wireless network that has transceivers having several modes of operation, including a limited interference mode that allows transceivers to only establish communication with localized wireless-enabled devices or a distant access mode that allows transceivers to communicate with distant wireless access points; d) enhanced user experience that is achieved by combining the configurable transceiver with a modified WIFI™ protocol; e) improved accuracy of the transmission of communication to the user as he/she moves around an environment; f) utilizes the information and experiences of other users to add information and improve accuracy of the information and experience; g) utilizes the information transmitted by other users to improve the information related to the distance above, below and around the observer; h) includes a system that can manage various formats of information, along with including the ability to search through the information system's history by using sophisticated and up-to-date search mechanisms and i) can provide promotional items or other information to a user based on the user's tracking input.

As mentioned above, there are many advantages to contemplated dynamic and interactive wireless information communication and delivery systems. Other advantages include: a) the observer will not generate noise and/or interference by using his/her smart phone or laptop to search for information on the internet, and b) companies can deliver content across both traditional “face to face” and mobile application platforms simultaneously.

Specifically, a wireless information communication and delivery system, as described herein, includes: a) at least one wireless-enabled device, b) a device location system, c) a positioning and communication system, and d) an information repository system. Many of the systems disclosed herein can be used in other contexts, which will be disclosed herein.

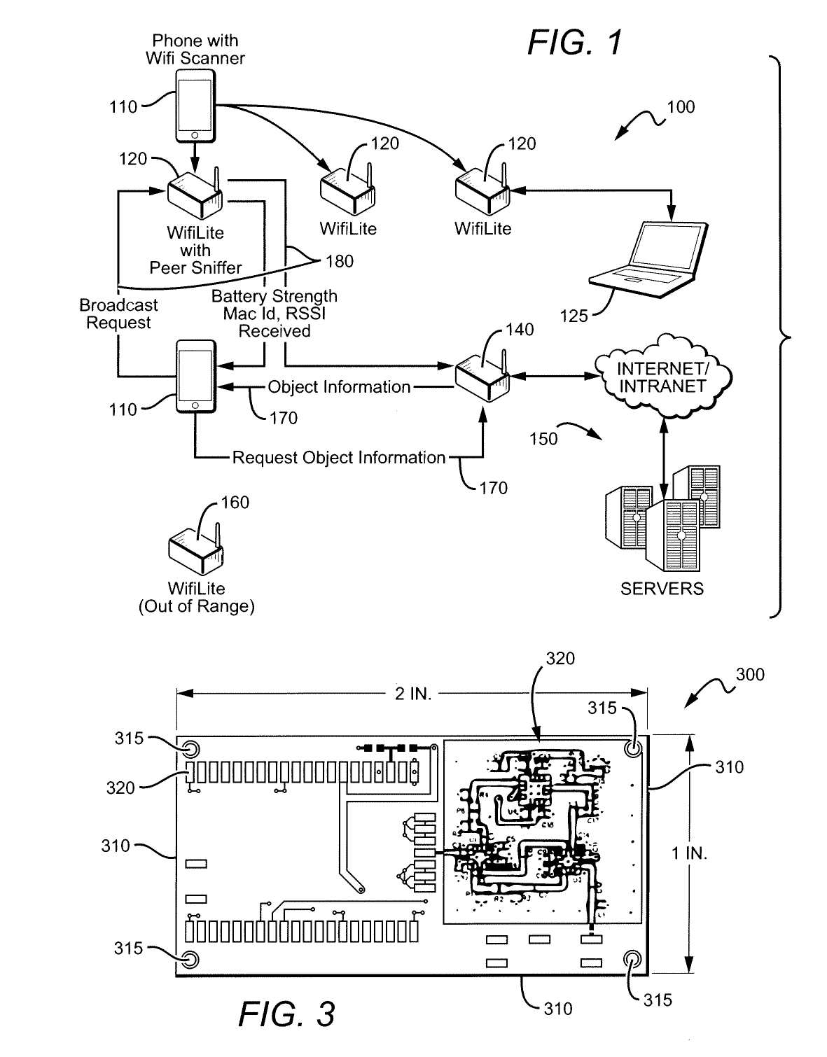

FIG. 1 shows a contemplated wireless information communication and delivery system 100 comprising a wireless-enabled device 110, a device location system comprising at least one transceiver 120, peer laptop 125 or combination thereof, a positioning and communication system comprising at least one reference point or access point 140 and an information repository system 150. FIG. 1 also shows a transceiver 160 that is out of range of the wireless information communication and delivery system.

A configurable wireless protocol device is disclosed that includes a multi-modal transceiver that can establish a communication network with a local wireless-enabled device, such as a smart phone or laptop. A wireless network is described that includes: at least one configurable wireless protocol device; at least one wireless-enabled device, and at least one wireless access point or a combination thereof. Contemplated wireless networks may also comprise other devices or electronics, including computers, laptop computers, hand-held and/or suitable devices. As used herein, the term “wireless” refers to wireless communication to a device or between multiple devices. Wireless devices may be anchored to a location and/or hardwired to a power system, depending on the needs of the business, venue, event or museum.

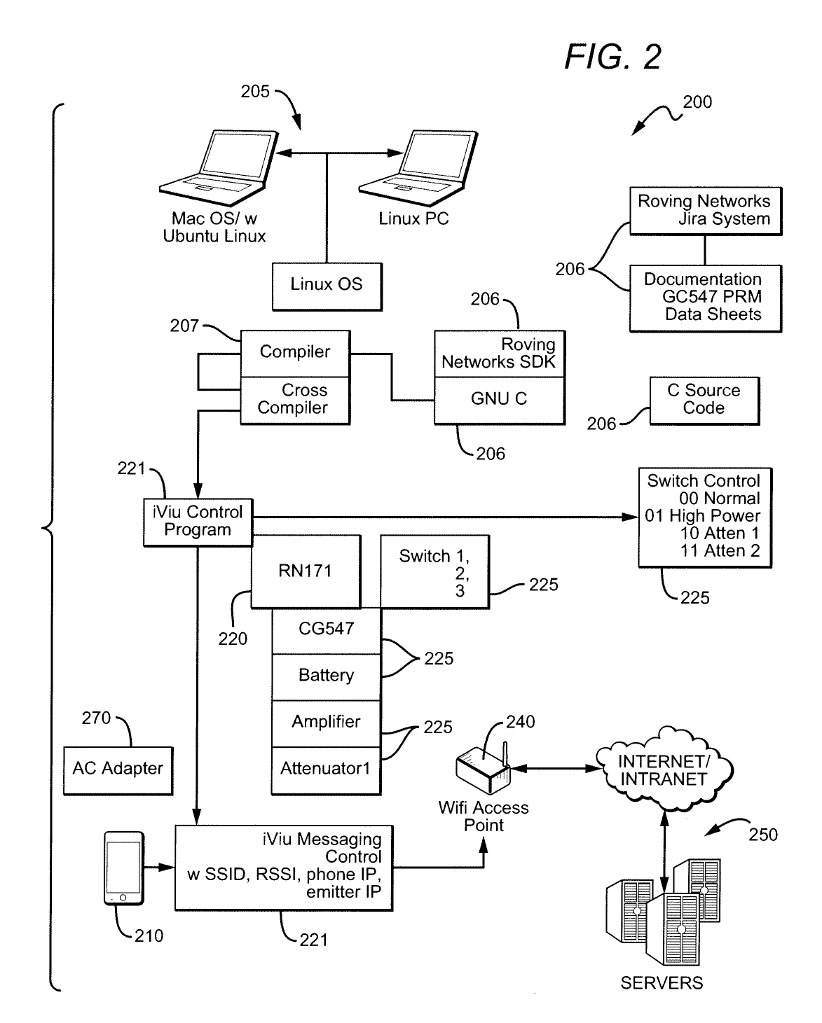

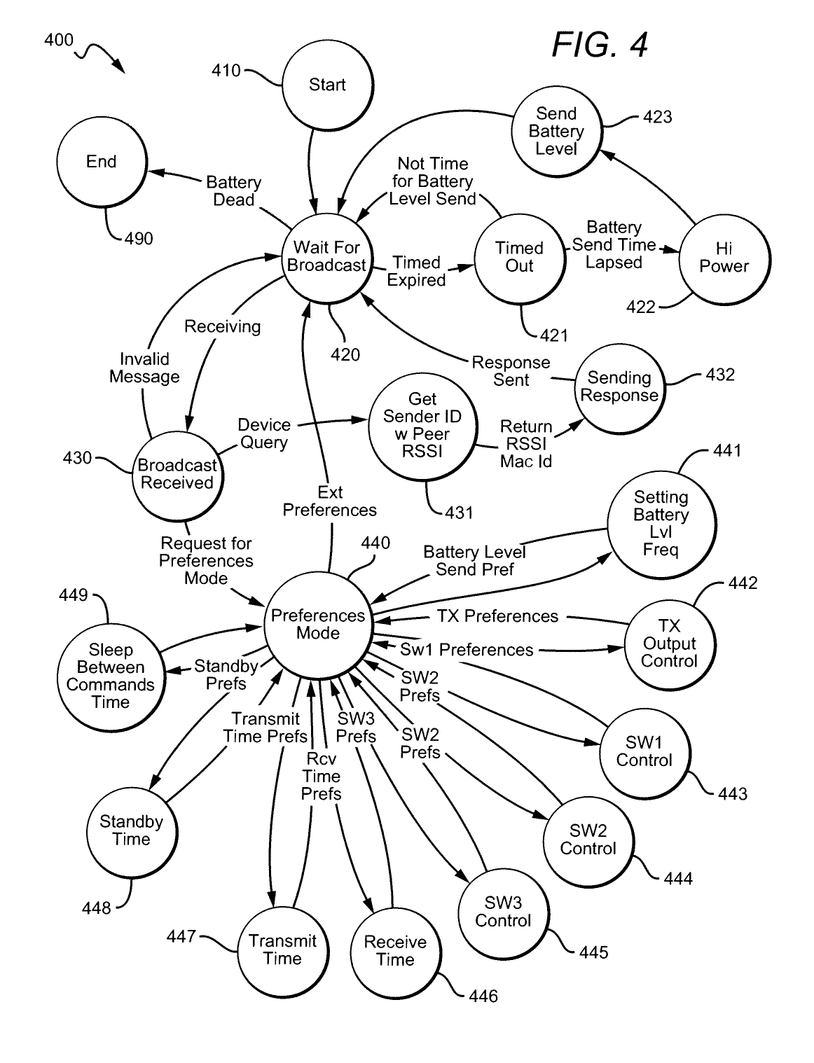

FIG. 2 shows a contemplated advanced network development diagram 200 that includes a wireless-enabled device 210, a device location system comprising at least one transceiver 220 and its contemplated components 225, a positioning and communication system comprising at least one reference point or access point 240 and an information repository system 250. This system shows that a contemplated network system can be developed and compiled on a computer system 205 using various available code 206 and compilers 207. The contemplated computer system 205 is then used to load the configurable wireless protocol 221 onto the at least one transceiver 220. An AC Adaptor 270 may be provided for the system 200.

Methods of locating a wireless-enabled device are described, also shown in FIG. 1 and include: providing a wireless-enabled device 110, providing a configurable wireless protocol device 120 comprising a modified wireless-protocol (not shown); and utilizing 170 the configurable wireless protocol device to actively scan 180 for the wireless-enabled device.

As mentioned, a contemplated wireless information communication and delivery system includes at least one wireless-enabled device. In some embodiments, contemplated wireless-enabled devices are those devices that provide for or allow two-way communication or at the very least, two-way activation. In other embodiments, contemplated wireless-enable devices are those devices capable of utilizing WIFI™, modified WIFI™ protocol or a protocol that is similar in concept and/or function as WIFI™ protocol, such as a configurable wireless protocol. If the wireless-enabled device does not provide for or allow two-way communication, then it must be able to be located by and it must receive communication wirelessly from another source. Contemplated wireless-enabled devices include at least one mobile phone, at least one smart phone, such as the iPhone™, Android™ or Blackberry® Torch™, at least one hand-held device, at least one laptop computer, at least one personal digital assistant or PDA, at least one ear transmitter and the like or a combination thereof.

Device location systems are also included as part of a dynamic wireless network and wireless information communication and delivery system. Contemplated device location systems comprise a transceiver or configurable wireless protocol device that can actively configure its signals to enable multiple operating modes, such as short range communication, long range communication or a combination thereof. A contemplated hardware transceiver 300 is shown in FIG. 3 that comprises an outer shell or case 310 with support nubs 315 and hardwire circuitry 320 designed to operate communications systems and related software (not shown). Contemplated transceivers are designed to be small, such as the one shown in FIG. 3, which is 1 inch by 2 inches. Contemplated device location systems also include a modified WIFI™ protocol that allows for location of and communication with contemplated wireless-enabled devices without the wireless-enabled device having to actively scan for the transceiver.

A configurable wireless protocol device is also contemplated that comprises a multi-modal transceiver that can establish a communication network with a local wireless-enabled device without first being communicated to by the wireless-enabled device. Contemplated transceivers can also establish a communication network with distinct wireless access points or reference points. In addition, contemplated transceivers comprise a modified wireless protocol software system, which may be modified WIFI™ protocol. In some embodiments, a contemplated configurable wireless protocol device comprises at least one attenuator, such as those already described herein. Contemplated attenuators can outline a range of space within which the wireless-enabled device is detected.

A contemplated device location system utilizes native TCP IP protocols to permit detection of relative distance or a specific distance range and those wireless-enabled devices within that distance range without the wireless-enabled device having to scan for the remote, configurable wireless devices, because that type of scanning is prohibited on some smart phones. Contemplated device location systems may also include attenuators to attenuate the signal, which enables the wireless information communication and delivery service to control the range within which the signal will be received.

As will be described in greater detail later, a contemplated configurable wireless device is a device that is a part of the wireless information communication and delivery system and is in communication with all of the components, including the wireless-enabled device, the positioning and communication system and the information repository system. Contemplated configurable wireless devices are generally stable, in that they are located near a trade show booth, a piece or work of art, a particular retail item or store location, a ride or attraction at a theme park, an item or group of items that are inventoried or any other article, item or service that someone would be interested in learning more about at a particular time.

Some contemplated features of device location systems include that the systems comprise configurable wireless protocol or WIFI™ devices, have a modified wireless or WIFI™ protocol that can be combined with the configurable WIFI™ devices or transceiver, and these device location systems may be able to control “slave” or dumb devices in order to allow implementation in environments where very low cost devices are required.

Contemplated dynamic wireless networks and wireless information communication and delivery systems also comprise a positioning and communication system. These positioning and communication systems are important and novel because they provide an incredibly accurate way to accurately and precisely locate an observer from a number of different vantage points, distance ranges and a number of different time characteristics, such as how long the person stands in front of a particular exhibit or booth. Observers are detected by nearby devices and tagged objects, and the relative signal strength will be communicated to the positioning and communication system to let the dynamic wireless network know that the observer is in range of a particular tagged area, including a tagged object, booth, room or other item. In contemplated embodiments, positioning and communication systems comprise a relative location system. These relative location systems comprise at least one reference or access point that is designed to communicate with the wireless network and wireless information and communication system, along with communicating with one another. The relative location system is also designed to collect information from the wireless-enabled device, including how long the device (user/observer) stood in a certain place or in front of a certain object (object level accuracy) and send that information to the information repository system.

Without the position and communication system, however, these observers would just get a list of items, objects or locations and would not know whether the tagged objects are to their left, right, in front, in back, above or below them. That is, they would know distance without any relative direction. The position and communication system uses the fact that observers are in an environment and that the observers move, giving them a different signal strength and estimated distance as they move around in the environment. If one object shows a stronger signal as an observer moves, while another object fades, the system will determine that the user is moving toward the object. As larger and larger numbers of these observations of users at different points are recorded, the “perspectives” in the information system are gathered and then used to provide a “learning” method by which more and more accurate information evolves.

In addition and in contemplated embodiments, certain “reference” points are established using the higher power WIFI™ access points in a room that will be place or, if they are already there, will have their coordinate positions relative to a room entrance recorded. The signals from these objects will provide a base from which to calibrate the signals from the other tagged devices and objects in the room. The strength and desirability of contemplated systems is that they allow for tagged object level accuracy on the range of 1 to 2 meters from the tagged object, which is possible because contemplated wireless information communication and delivery systems use special WIFI™-based or wireless protocol-based tags that intentionally control the signal level combined with the contemplated position learning system to provide the increase object level accuracy rather than room level accuracy.

A positioning and communication system that is part of a dynamic wireless network is also contemplated that comprises a relative location system. As mentioned, the relative location system assigns a user a different or unique signal strength and estimated distance as the user moves around in a specific environment. In some embodiments, a contemplated environment comprises a museum, a room, a trade show floor, a historic house, an automobile show, a geographic location, an amusement park, a retail location or a shopping mall.

Some contemplated wireless-enabled devices will use the TCP/IP broadcast/receive mechanism used in the wireless information communication and delivery systems. Other wireless-enabled device models that allow WIFI™ scanning will use scanning to get the same signals and thus reduce the amount of message traffic necessary, while at the same time also save battery life on the tagged objects and related devices. This contemplated device based solution associated with a software only solution on the wireless-enabled devices provides an unprecedented level of detail for solutions without any custom hardware on the observer wireless-enabled devices. Contemplated wireless information communication and delivery systems require that software-based digital data tags be associated with the tagged objects and appropriate applications software be downloaded and activated on the wireless-enabled devices, as shown in FIG. 4 and described in the Examples section.

Contemplated wireless information communication and delivery systems also comprise an information repository system. These contemplated repository systems comprise a database or other storage means for storing information about all of the tagged objects or locations, whether they are pieces of art, rooms in a historic house, trade show booths and other contemplated tagged objects or locations. Contemplated objects and locations that are associated with a place may also be related to associated objects. Contemplated place and object relationships are also recursive, so that a place contained in another place may also itself contain other places. The same is true for objects. Contemplated information repository systems also comprise a database or other storage means to store information about the observers, users or customers with wireless-enabled devices that are in use with the wireless information communication and delivery system.

Information about these tagged places and objects contains associated Uniform Resource Identifiers (URIs). A URI could contain a single Uniform Resource Locator (URL) if it is just a web page or the URI could itself contain various types of information such as videos, audio files, pictures, HTML pages, etc. The information can be updated on the fly or in real time, as information is generated about the item, object, event or company. Contemplated places and objects are also tagged to both absolute (longitude and latitude) and relative (x,y,z coordinates based on an entry point) locations. The repository contains a history of movements by observers around the contemplated environment. The information repository also contains a “transactions” component that will track expressions of interest by observers in places and objects as well as their route through the places enabled for this type of wireless information communication and delivery systems. The perspectives history contained in contemplated wireless information communication and delivery systems enables the positioning functionality used by the position and communication system, which, as mentioned, records distance, signal strength and other information related to the current position of the observer.

The position and communication system works in concert with the contemplated information repository system to track users within the environment, develop sophisticated demographics and analytics of the users and to push out information regarding moved tagged objects, new tagged objects to the environment, new information regarding tagged objects and other valuable information. Contemplated systems also allow users to retrieve real-time information regarding objects they are viewing as well as replaying their routes and the information regarding objects that they may have bookmarked during the tour or visit.

### EXAMPLES

### Contemplated Messaging Protocol for Positioning: Smart Phone

Table I outlines some of the messages that can be processed by contemplated wireless-enabled devices—in this case, smart phones. These messages are further described below. FIG. 4 shows a contemplated digital tag system 400 for a configurable transceiver (not shown). After start 410, the transceiver waits for broadcast 420 and sends or receives several contemplated messages, such as Timed Out 421, Hi Power 422, Send Battery Level 423 or Broadcast Received 430. The Broadcast Received mode 430 then can send a device query 431 and then send the response 432 back to the transceiver. The Broadcast Received mode 430 will also send a request to the Preferences Mode 440, which is described below.

Messages IV00001 and IV00002 are the messages received from and sent to the phones respectively. IV00001 will be received from phones probing for signal strength and thus, proximity. An IV00001 message will contain a comma separated message that will include: IP:xxx.xxxmx.xxx which is the IP of the sending phone. These IV00001 messages will be broadcast to all devices in range so that all digital tags or DTs receiving this message can respond with their signal strength.

The phone will respond with IV00002, which will contain the device ID of the device (initially the MAC address of the wifi-lite or transceiver digital tag). It will also return the signal strength with which it received the IV00001 message from the phone. There is one trick to this which is that the device will be placed in “Sniffer” mode so that it will see all messages on the network even though it is in “Infrastructure” mode which would normally ignore any messages not sent to it as an access point. In this “Sniffer” mode the DT will receive the RSSI directly from the sending phone whereas in normal Infrastructure mode the RSSI would be the RSSI from the nearest access point which would not provide the necessary positioning information to the phone. The responding message will return directly to the phone that sent it.

### Preferences Settings Mode

Because the devices may be encountered in a wide diversity of settings the need for them to operate efficiently, saving energy and thus prolonging battery life while also providing rapid response to nearby Observers, the devices will have a “Preferences” mode 440. These preferences will allow the optimization based on the following considerations: a) memory for stored messages and b) response time to requests. For example if we have 100 people moving around and requesting their position every two seconds that would be 30×100 or 3,000 messages per minute. If it slept a minute it would have a long list of messages, plus users wouldn't get answers back until they had probably moved beyond the both where the device is located. if we are fast enough we can probably get away with a 1 second sleep but because we really can't expect to use a fixed number.

FIG. 4 shows a contemplated Preferences Mode 440 where various preferences are contemplated, such as setting battery level frequency 441, TX output control 442, SW1 Control 443, SW2 Control 444, SW3 Control 445, Receive Time 446, Transmit Time 447, Standby Time 448, and Sleep Between Commands Time 449. There may be other contemplated Preferences as contemplated systems are utilized and configured.

Preferences Messages: Message IV10000 places the device in “Preferences Mode so that all preferences messages while in this mode will cause changes to the stored preferences. IV19999 with a “1” will cause the device to exit the preferences mode and store the changes in persistent memory. If a “0” is sent with IV19999 the DT will exit preferences mode and throw away all changes made since entering preferences mode.

The preferences mode will allow control of: Battery time before power level update. Message (Table I) IV20001. This sets the time, in minutes, between the sending of the battery level of the DTs. This is done to monitor the batteries for the need to replace them. The DTs will have to be put in high power mode so that the signal will reach the nearby access points and not just the phones within the low power range. This will be a 5 digit number from 0 to 99999 minutes. 0 indicates that the DT never sends battery information; b) Settings for switches 1, 2, 3 IV20002 sends a 3 digit number from 000 to 111. The 0s and 1 s indicate the on off state for switches 1, 2 and 3 by position. So, for example, value 111 would turn on all three switches while 010 would turn on switch 2 and turn switches 1 and 3 off; c) Sleep Time; and d) Variable transmit power.

Development Technology: Code will be developed using a GNU C compiler with code cross compiled to the RN171 chip using a development board. Eclipse will be used as a development IDE with the C plug in utilized.

Change Control: CVS Change control will be used to provide version control and development team collaboration.

Debugging: The GNU Debugger will be used for Debugging.

TABLE I
DEVICE TAGS MESSAGING PROTOCOLS

| Message Id | Description | Content | TX LVL | SW 1 | SW 2 | SW 3 | Notes |
|---|---|---|---|---|---|---|---|
| IV00001 | Request Device | (1) | n/a | n/a | n/a | n/a | |
| | ID, RSSI | | | | | | |
| IV00002 | Response fr | (2) | n/a | n/a | n/a | n/a | |
| | Device | | | | | | |
| IV10000 | Enter | | n/a | n/a | n/a | n/a | |
| | Preferences Mode | | | | | | |
| IV19999 | Exit | 1 or 0 | n/a | n/a | n/a | n/a | 1 stores all changes, |
| | Preferences Mode | | | | | | 0 cancels the changes |
| | | | | | | | since IV10000 |
| IV20001 | Set Battery | n Min | n/a | n/a | n/a | n/a | |
| | Level Send Freq | | | | | | |
| IV20002 | Set Switches | “000 | n/a | Off | Off | Off | |
| IV20002 | | 1 | n/a | Off | Off | 1 | |
| IV20002 | | 10 | n/a | Off | On | Off | |
| IV20002 | | 11 | n/a | Off | On | On | |
| IV20002 | | 111 | n/a | On | On | On | |
| IV20002 | | etc. | n/a | | | | binary number 8 |
| | | | | | | | settings 000 to 111 |
| IV20010 | Set Tx Lvl | 0-12 | 0-12 | n/a | n/a | n/a | |
| IV29999 | Settings Result | −1 0 | n/a | n/a | n/a | n/a | Failed OK |

1. Msg Id + “,” + “IP:” + sending IP address
2. Msg Id + “,” + “IP:” + sending (emitter) IP Address
3. “,” + “RSSI” + signal strength received from device

Thus, specific embodiments and applications of dynamic wireless networks and interactive wireless information communication and delivery systems have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the disclosure, all terms and claims should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A wireless information communication and delivery system, comprising:
at least one wireless-enabled device,
a device location system,
a positioning and communication system, and
an information repository system.

2. The wireless information communication and delivery system of claim 1, wherein the wireless-enabled device comprises a two-way communication device.

3. The wireless information communication and delivery system of claim 2, wherein the two-way communication device comprises a smart phone, a hand-held device, a personal digital assistant or at least one ear transmitter.

4. The wireless information communication and delivery system of claim 1, wherein the device location system comprises at least one transceiver, a configurable wireless device or a combination thereof.

5. The wireless information communication and delivery system of claim 1, wherein the positioning and communication system comprises a relative location system.

6. The wireless information communication and delivery system of claim 5, wherein the relative location system comprises at least one reference point.

7. The wireless information communication and delivery system of claim 1, wherein the positioning and communication system allows for object level accuracy.

8. The wireless information communication and delivery system of claim 1, wherein the information repository system comprises a database design or other storage means.

9. The wireless information communication and delivery system of claim 1, wherein the information repository system comprises a system that collects demographics and analytics from a user or operator.

10. A device location system that is part of a dynamic wireless network, comprising a transceiver and a modified wireless protocol.

11. The device of claim 10, wherein the transceiver actively configures its signals to enable multiple operating modes.

12. The device of claim 10, wherein the multiple operating modes comprises long range communication, short range communication or a combination thereof.

13. The device of claim 10, wherein the modified wireless protocol comprises a modified WIFI™ protocol.

14. A positioning and communication system that is part of a dynamic wireless network, comprising a relative location system.

15. The positioning and communication system of claim 14, wherein the relative location system assigns a user a different signal strength and estimated distance as the user moves around in an environment.

16. The positioning and communication system of claim 15, wherein the environment comprises a museum, a room, a trade show floor, a historic house, an automobile show, a geographic location, an amusement park, a retail location or a shopping mall.

17. A configurable wireless protocol device, comprising a multi-modal transceiver that can establish a communication network with a local wireless-enabled device.

18. The configurable wireless protocol device of claim 17, wherein the transceiver can also establish a communication network with distinct wireless access points.

19. The configurable wireless protocol device of claim 17, wherein the transceiver comprises a modified wireless protocol software system.

20. The configurable wireless protocol device of claim 19, wherein the modified wireless protocol software system is a modified WIFI protocol.

21. The configurable wireless protocol device of claim 17, wherein the multi-modal transceiver comprises short range communication mode, long range communication mode or a combination thereof.

22. The configurable wireless protocol device of claim 17, further comprising at least one attenuator.

23. The configurable wireless protocol device of claim 22, wherein the at least one attenuator outlines a range of space within which the wireless-enabled device is detected.

24. A wireless network, comprising:
at least one configurable wireless protocol device;
at least one wireless-enabled device; and
at least one wireless access point.

25. A method of locating a wireless-enabled device, comprising:
providing a wireless-enabled device,
providing a configurable wireless protocol device comprising a modified wireless-protocol; and
utilizing the configurable wireless protocol device to actively scan for the wireless-enabled device.
